(19) United States
(12) Patent Application Publication
(10) Pub. No.: US 2017/0265655 A1
(43) Pub. Date: Sep. 21, 2017

(54) FOLDABLE DISPLAY UNITS

(71) Applicant: Great Northern Corporation, Appleton, WI (US)

(72) Inventors: Andy Kinzelman, Racine, WI (US); Bill Cozad, Mount Pleasant, WI (US); Scott Imhoff, Arlington Heights, IL (US); Josh May, Drexel Hill, PA (US)

(73) Assignee: Great Northern Corporation, Appleton, WI (US)

(21) Appl. No.: 15/461,697

(22) Filed: Mar. 17, 2017

Related U.S. Application Data
(60) Provisional application No. 62/309,715, filed on Mar. 17, 2016.

(51) Int. Cl. A47F 5/11; A47B 96/06; G09F 5/02

(52) U.S. Cl. CPC A47F 5/116; G09F 5/02; A47B 96/06

(57) ABSTRACT

A display unit movable between a disassembled position and an assembled position having a back wall, a first sidewall extending from a first side end of the back wall, a second sidewall extending from a second side end of the back wall, and a plurality of shelves that are operably coupled to the back wall, the first sidewall, and the second sidewall. The shelf has a support surface that is parallel to the back wall when the display unit is in the disassembled position. The support surface is configured to be transverse to and extend from the back wall when the display unit is in the assembled position.

### CROSS REFERENCE TO RELATED APPLICATION

The present application is based on and claims priority to U.S. Provisional Patent Application Ser. No. 62/309,715 filed Mar. 17, 2017, the disclosure of which is incorporated herein by reference.

### FIELD

The present disclosure relates to foldable display units, specifically foldable display units that can be quickly erected at a desired location.

### BACKGROUND

Foldable display units are used to display items (e.g. merchandise items) to customers. In certain examples, the display units are shipped to the store in a disassembled or collapsed position, which reduces the shipping space required to ship the display unit. These display units are then erected into an assembled or erected position at the store. It is often desirable to minimize the amount of time and/or materials required to erect the display unit from the disassembled position to the assembled position. It is further desirable to increase display unit quality and/or increase erection consistency. It is further desirable to construct the display unit in such a way that the display unit can be repeatably moved and/or collapsed.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a display unit includes a back wall having a first side end and a second side end opposite the first side end, a first sidewall extending from the first side end, and a second sidewall extending from the second side end. The display unit is movable between a disassembled position and an assembled position such that the first sidewall is coplanar with the back wall when the display unit is in the disassembled position and transverse to the back wall when the display unit is in the assembled position and the second sidewall is coplanar with the back wall when the display unit is in the disassembled position and transverse to the back wall when the display unit is in the assembled position. A shelf is operably coupled to the back wall, the first sidewall, and the second sidewall, and the shelf includes a support surface that is parallel to the back wall when the display unit is in the disassembled position and transverse to and extending from the back wall when the display unit is in the assembled portion.

In certain examples, a display unit is movable between a disassembled position and an assembled position. The display unit has a back wall having a first side end, a second side end opposite the first side end, a first back wall portion, and a second back panel portion opposite the first back panel portion. The first back panel portion is parallel to the second back panel portion when the display unit is in the disassembled position; and the first back panel portion and the second back wall portion are coplanar when the display unit is in the assembled position. A first sidewall extends from the first side end such that the first sidewall is coplanar with the back wall when the display unit is in the disassembled position and transverse to the back wall when the display unit is in the assembled position. A second sidewall extends from the second side end such that the second sidewall is coplanar with the back wall when the display unit is in the disassembled position and transverse to the back wall when the display unit is in the assembled position. The second sidewall and the first sidewall are parallel to each other when the display unit is in the assembled position. At least one shelf having a support surface and a lip is operably coupled to the back wall, the first sidewall, and the second sidewall. The support surface and the lip are parallel to the back wall when the display unit is in the disassembled position; and the support surface is transverse to and extends from the back wall and the lip is transverse to the support surface when the display unit is in the assembled position.

### BRIEF DESCRIPTION OF THE DRAWINGS

The present disclosure is described with reference to the following Figures. The same numbers are used throughout the Figures to reference like features and like components

FIG. 1 is an example display unit in an assembled position.

FIG. 2 is the example display unit of FIG. 1 in a disassembled position.

FIG. 3 is the example display unit of FIG. 1 moving from the disassembled position to an intermediate position.

FIG. 4 is a front view of the example display unit of FIG. 1 in the intermediate position.

FIG. 5 is a back view of the example frame when the display unit is in the intermediate position.

FIG. 6 is another example of the frame.

FIGS. 7-10 depict an example construction sequence for an example frame.

FIGS. 11-15 depict an example construction sequence for an example shelf.

FIGS. 16-18 depict the example shelf of FIGS. 11-15 being attached to an example frame (which is partially depicted).

FIG. 19 is an example frame (which is partially depicted).

FIG. 20 is an enlarged view within line 20 depicted on FIG. 19.

FIG. 21 is an example support bar.

FIG. 22 is an example shipping box.

FIGS. 23-24 depicts a display unit in the disassembled position being placed into an example shipping box.

FIG. 25 depicts multiple shipping boxes containing display units in the disassembled position.

### DETAILED DESCRIPTION

The present disclosure describes examples of foldable merchandise display units 10 which can be quickly and easily erected at a desired location where items (e.g. merchandise items) are to be displayed to consumers (e.g. department stores, convenience stores). The display units 10 are collapsible and/or can be folded into a relatively thin and flat shape for shipping and storage. The display units 10 are made out of corrugated paperboard, plastic, or other suitable material.

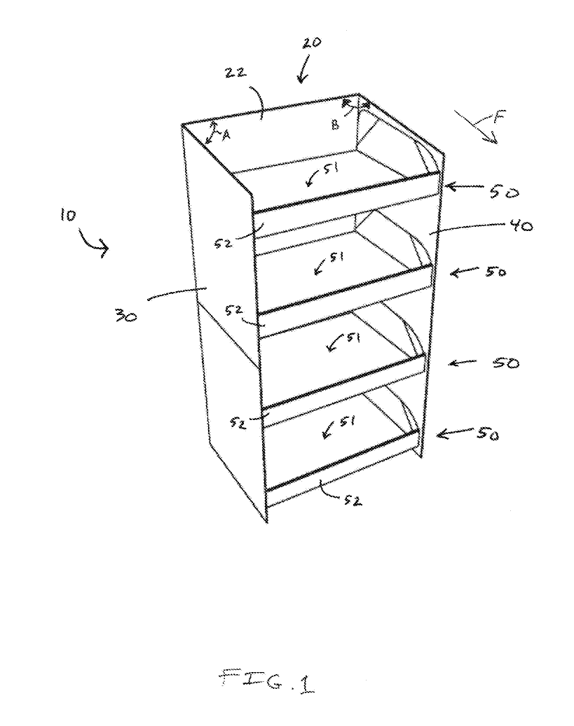

Referring to FIG. 1, an example foldable merchandise display unit 10 is depicted in an assembled or erected position. The display unit 10 includes a frame 20 (described herein) and four shelves 50 (described herein) that are configured to horizontally support merchandise items (not shown) that are placed into the display unit 10.

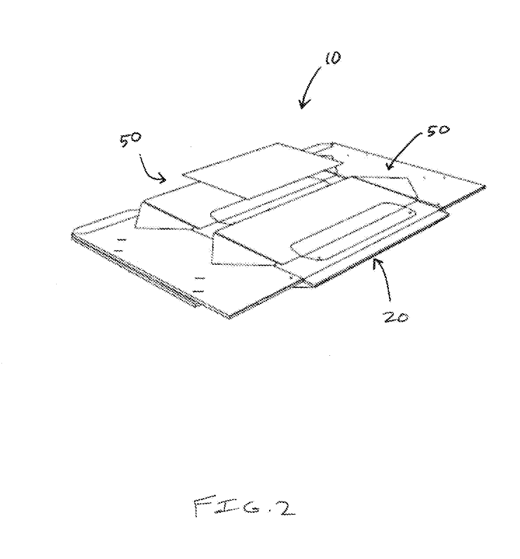

The display unit 10 can be moved into and between the assembled position (FIG. 1) in which the display unit 10 can horizontally support merchandise items on the plurality of shelves 50 and a disassembled position (FIG. 2) in which the display unit 10 is collapsed into a compact shape. When the display unit 10 is in the disassembled position (FIG. 2), the display unit 10 is easily transported or shipped. In certain examples, tall display units 10 may be configured to fold about score lines and/or fold lines (which are described further herein) (i.e. the frame 20 includes score lines that allows the frame 20 to fold in half). In these examples, the display unit 10 moves into and between the disassembled position (FIG. 2), an intermediate position (FIG. 4) in which walls of the frame 20 are coplanar, and the assembled position (FIG. 1). FIG. 3 depicts the display unit 10 moving from the disassembled position (FIG. 2) to the intermediate position. FIG. 4 depicts the display unit 10 in the intermediate position.

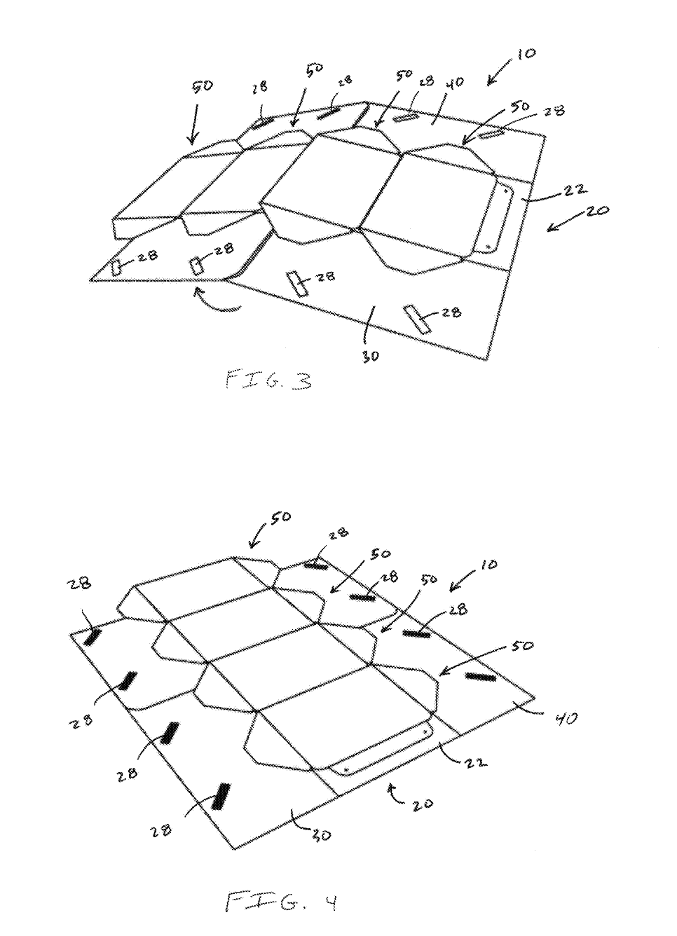

Referring to FIG. 5, the back of the frame 20 in depicted when the display unit is in the intermediate position as compared to the front view of FIG. 4. The frame 20 includes a back wall 22 having a first side end 23 and a second side end 24 opposite the first side end 23 and a pair of sidewalls, namely a first sidewall 30 and a second sidewall 40. The first sidewall 30 extends from the first side end 23, and the second sidewall 40 extends from the second side end 24. The sidewalls 30, 40 are coplanar with the back wall 22 when the display unit 10 is in the disassembled position (FIG. 2) and/or the intermediate position (FIG. 4), and the sidewalls 30, 40 are transverse to the back wall 22 when the display unit 10 is in the assembled position (FIG. 1). That is, the sidewalls 30, 40 are configured to fold or pivot toward each other such that the sidewalls 30, 40 extend from the back wall 22. In certain examples, the sidewalls 30, 40 fold or pivot toward each other such that an angle A defined between the first sidewall 30 and the back wall 22 is equal to an angle B between the second sidewall 40 and the back wall 22 (see FIG. 1). In certain examples, the sidewalls 30, 40 fold or pivot toward each other such the sidewalls 30, 40 are parallel to each other. One having ordinary skill in the art with recognize that the orientation of the sidewalls 30, 40 can vary (e.g. the sidewalls 30, 40 are transverse relative to each other).

Referring back to FIG. 5, the frame 20 includes a longitudinal score line 25 at each side end 23, 24 of the back wall 20 to facilitate folding or pivoting of the sidewalls 30, 40 toward each other. The frame 20 also includes a lateral score line 26 that is transverse to the longitudinal score lines 25. The lateral score lines 26 facilities folding of the back wall 22 and sidewalls 30, 40 in half. That is, the lateral score line 26 divides the back wall 22 into first back wall portion 22A and a second back wall portion 22B opposite the first back wall portion 22A; the first sidewall 30 into first sidewall portion 30A and a second sidewall portion 30B opposite the first sidewall portion 30A; and the second sidewall 40 into a third sidewall portion 40A and a fourth sidewall portion 40B opposite the third sidewall portion 40A. In this example, when the display panel is in the disassembled position (FIG. 2) the first back wall portion 22A is parallel to the second back wall portion 22B, the first sidewall portion 30A is parallel to the second sidewall portion 30B; and the third sidewall portion 40A is parallel to the fourth sidewall portion 40B (i.e. the first back wall portion 22A is next to the second back wall portion 22B, the first sidewall portion 30A is next to the second sidewall portion 30B, and the third sidewall portion 40A is next to the fourth sidewall portion 40B). Subsequently, when the display unit 10 is moved to the intermediate position (FIG. 4) and/or the assembled position (FIG. 1) the first back wall portion 22A is coplanar to the second back wall portion 22B, the first sidewall portion 30A is coplanar with the second sidewall portion 30B, and/or the third sidewall portion 40A is coplanar with the fourth sidewall portion 40B. The shape and size of the score lines 25, 26 can vary. One of ordinary skill in the art will also recognize that the score lines described herein can be interchangeable with fold lines, perforation lines, and/or the like to facilitate folding or pivoting of various components of the display unit 10 described herein.

The shape, size, and construction of the frame 20 can vary. Referring to FIG. 6, the frame 20 is a single sheet of planer material (i.e. the back wall, the first sidewall, and the second sidewall are an integral single contiguous material panel). The single sheet of material in the shown embodiment is a sheet of corrugated cardboard. However, other similar materials could be used. The sidewalls 30, 40 each include a secondary longitudinal score line 27 that facilitates folding on the sidewalls 30, 40 in half to thereby increase the overall material thickness of the sidewalls 30, 40 (see fold arrows B). In this example, the halves of the sidewall 30, 40, are coupled together with fasteners 28 (e.g. tape, adhesives, mechanical fasteners).

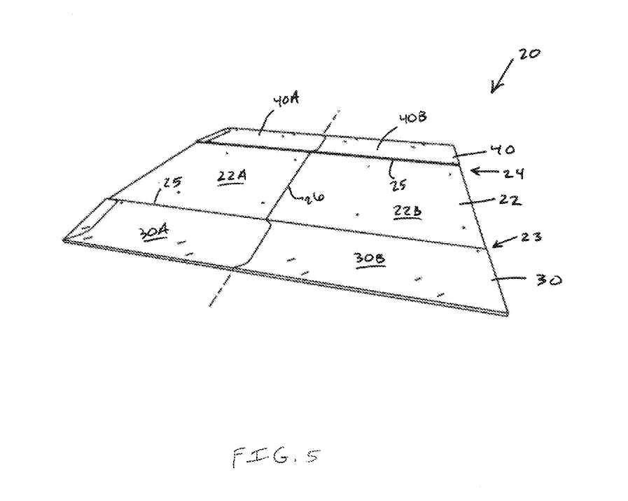

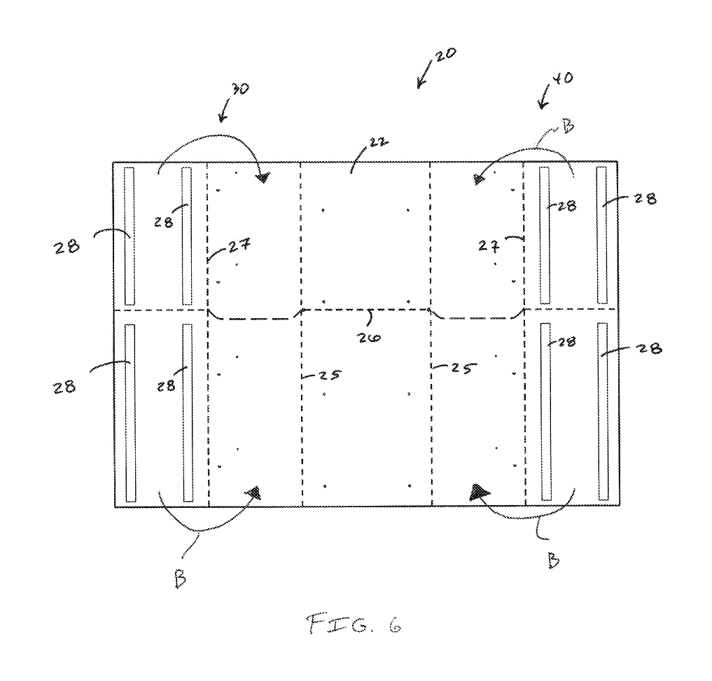

Referring to FIGS. 7-10, the frame 20 includes a reinforcing panel 29 that reinforces the first sidewall 30 to thereby increase the stability and overall material thickness of the first sidewall 30. Note that one reinforcing panel 29 is depicted in FIGS. 7-10, and a person having ordinary skill in the art will recognize that an additional reinforcing panel 29 can be coupled to the second sidewall 40. The reinforcing panel 29 includes a plurality of score lines 33 that define panels, and the reinforcing panel 29 is coupled or adhered to the first sidewall 30 with fasteners 28 (e.g. tape, adhesives, mechanical fasteners). FIG. 7 depicts a back surface of the first sidewall 30 being placed onto the reinforcing panel (see motion arrow C). FIG. 8 depicts sections of the reinforcing panel 29 folding onto a top surface of the first sidewall 30 (see motion arrow D). FIG. 9 depicts a section of the reinforcing panel 29 folding onto the top surface of the first sidewall (see motion arrow E). FIG. 10 depicts the first sidewall 30 with the reinforcing panel 29. FIGS. 10 depicts the reinforcing panel 10 attached to the first sidewall 30.

Referring back to FIG. 1, the display unit 10 includes at least one shelf 50 that includes a support surface 51. In certain examples, the shelf 50 includes a lip 52. The shelf 50 is operably coupled to back wall 22, the first sidewall 30, and/or the second sidewall 40 such that when the display unit 10 is in the assembled position (FIG. 1), the support surface 51 horizontally supports items placed in the display unit 10 and the lip 52 is positioned transverse to the support surface 51 to thereby prevent items from falling off of the display unit in direction F (FIG. 1). When the display unit 10 is in the disassembled position (FIG. 2), the support surface 51 and the lip 52 are parallel to the back wall 22 (i.e. the support surface 51 and the lip 52 fold flat against the back wall 22) and co-planar to each other (i.e. the support surface 51 and the lip 52 lie substantially in the same plane when the display unit 10 is in the disassembled position (FIG. 2)). Fasteners 28 (e.g. tape, adhesives) fasten the shelves 50 to the sidewalls 30, 40 (see FIGS. 3-4). In certain examples, the fasteners are hook-and-loop strips (e.g. Velcro) that allow the shelves 50 to detach from the sidewall 30, 40 such that the display unit 10 can be repeatably moved into and between the assembled position (FIG. 1) and the disassembled position (FIGS. 2). The number of shelves 50 included with the display unit 10 can vary (e.g. four shelves). The shelves 50 and the frame 20 can be made out of any suitable material such as corrugated paperboard, plastic, and/or the like.

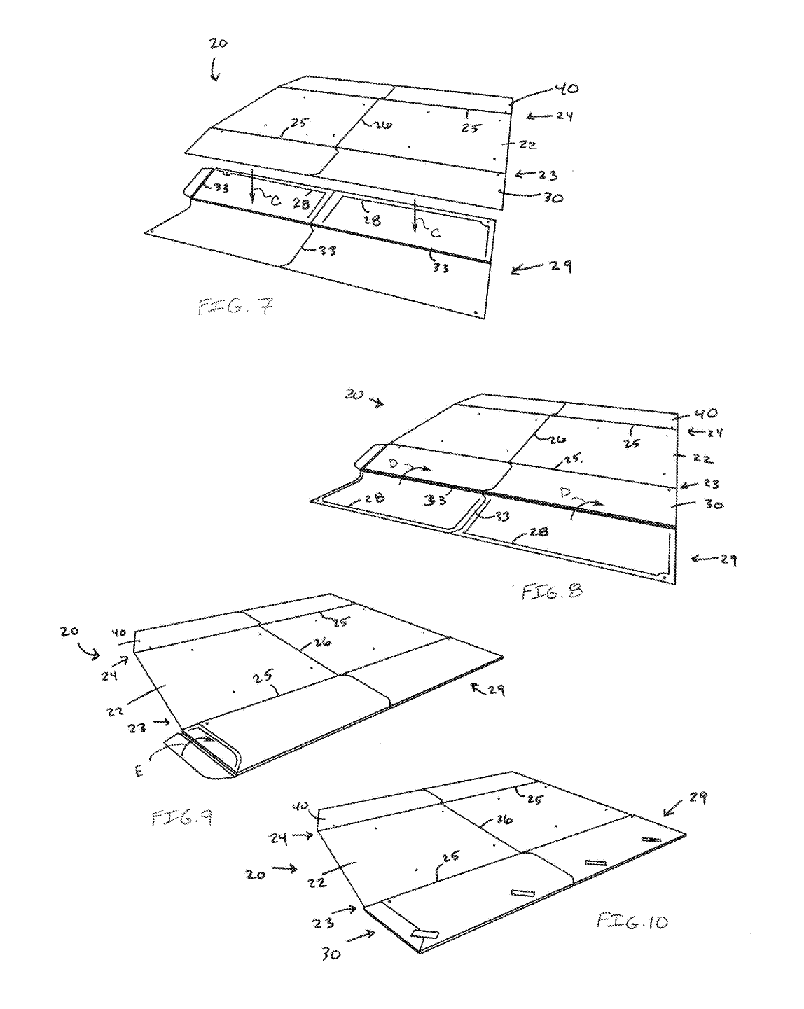

The size, shape, and construction of the shelf 50 can vary. Referring to FIGS. 11-15, the shelf 50 is constructed form a single contiguous material panel. The shelf 50 includes a plurality of score lines 54 define a plurality of shelf sections 56 and facilitate folding of the shelf 50 thereby form components (e.g. the support surface 51, the lip 52) of the shelf 12. An example folding sequence for the shelf 50 is described below.

In FIG. 11, panel 56A folds along score line 54A panel 56B (see motion arrow G). Panel 56A is coupled to panel 56B by a fastener (not shown).

In FIG. 12, the shelf 50 is rotated 180 degrees relative to the orientation of the shelf depicted in FIG. 11 (i.e. shelf 50 is flipped upside down). Panel 56B and panel 56C are folded about fold line 54B onto panel 56D (see fold arrow H).

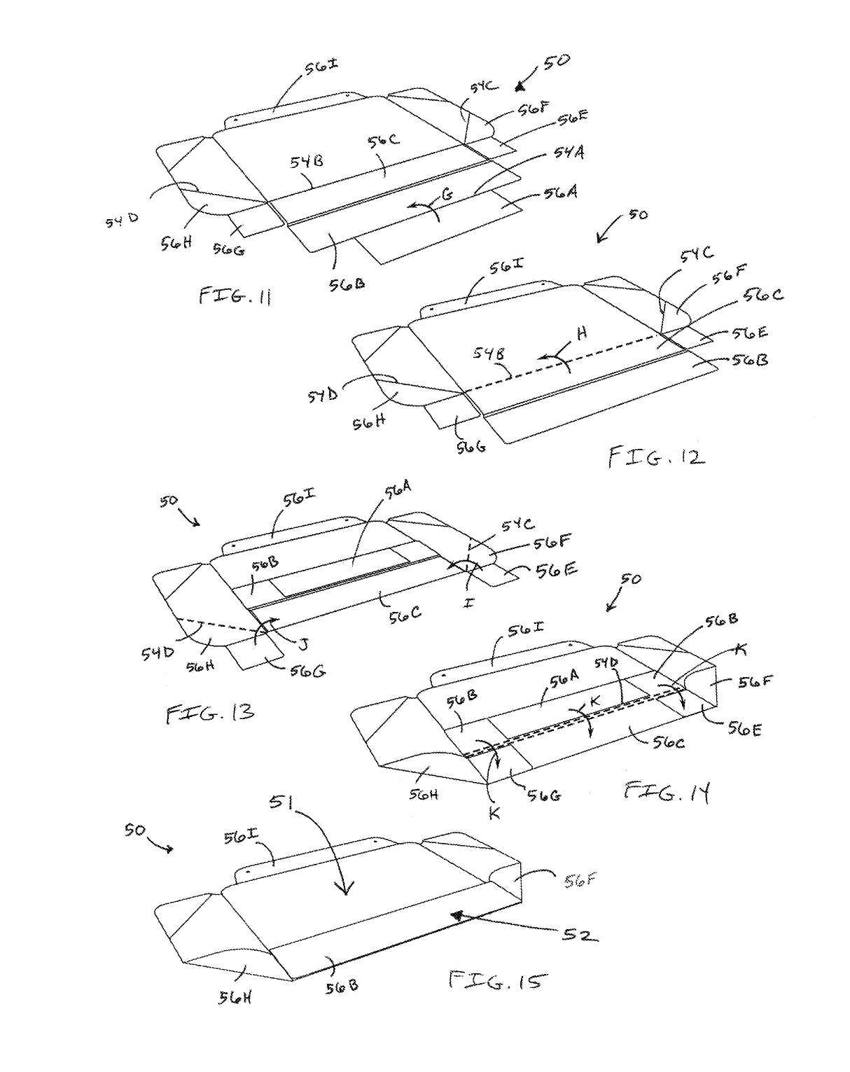

In FIG. 13, panels 56E and 56F are folded along fold line 54C such that panel 56E is fastened with a fastener (not shown) to 56C (see fold arrow I). Similarly, panels 56G and 56H are folded along fold line 54D such that panel 56G is fastened with a fastener (not shown) to 56C (see fold arrow J).

In FIG. 14, panels 56A and 56B are folded along fold line 54D such that panel 56A is fastened with a fastener (not shown) to 56C and panel 56B is fastened with a fastener (not shown) to panel 56E and panel 56G (see fold arrows K).

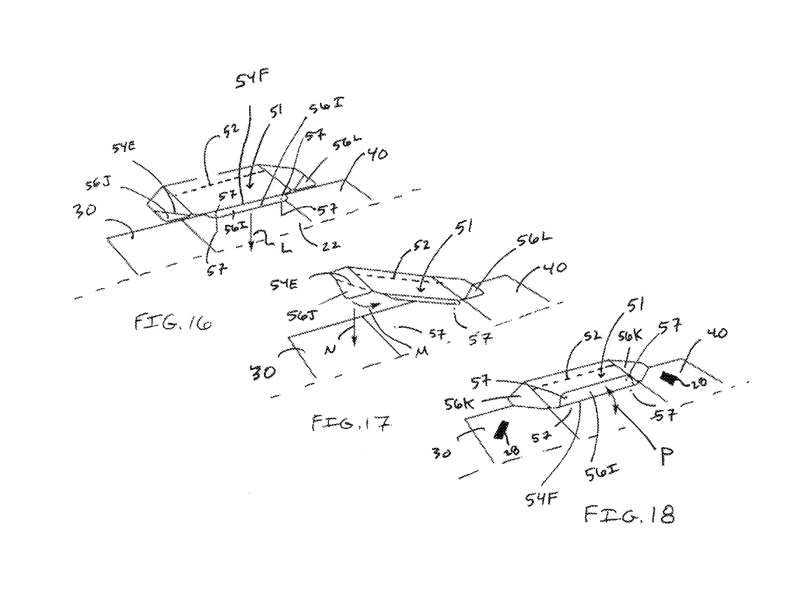

In FIG. 15, the shelf 50 is fully formed with the support surface 51 and the lip 52.

As mentioned briefly above, the shelf 50 is operably coupled to the back wall 22, the first sidewall 30, and the second sidewall 40. Referring to FIGS. 16-18, an example sequence for attaching the shelf 50 to the frame 20 is depicted. One having ordinary skill in the art will recognize that the sequence for attaching the shelf 50 to the frame 20 can vary.

In FIG. 16, the formed shelf 50 (see FIG. 15) is aligned with the back wall 22 such that the lip 52 is positioned between the back wall 22 and the support panel (i.e. with references to FIGS. 16-18, the lip 52 is shown in dashed lines and underside of the support surface 51 is visible). Once the shelf 50 is properly aligned, panel 56I is moved into position (see motion arrow L) (i.e. the shelf 50 is moved to abut the back wall 22). Alignment indicators 57 (e.g. holes, indicia) are included on the back wall 22 and/or the shelf 50. Guidepins (not shown) may be used with the alignment indicators 57 to thereby align the shelf on the frame 20.

In FIG. 17, one side of the shelf 50 is pivoted away from the back wall 22 such that panel 56J can be folded along fold line 54E in the direction of fold arrow M). Panel 56J is then fastened with a fastener (not shown) to the first sidewall 30 (see motion arrow N). The opposite side of the shelf 50 is then pivoted away from the back wall 22 (while the panel 56J stays fastened to the first sidewall 30) such that panel 56L can be fastened with a fastener (not shown) to the second sidewall 30 as described with respect to the panel 56L (note that the folding of panel 56L is mirrored with respect to panel 56J).

In FIG. 18, panel 56I is folded along fold line 54F and fastened with a fastener (not shown) to the back wall 22 (see fold arrow P). In certain examples, multiple shelves 50 can be attached to the frame 20 in the same sequence (see FIG. 1). When the display unit 10 is moved into the assembled position (FIG. 1), panels 56F, 56H (FIG. 15) are fastened to the sidewalls 30, 40 with fasteners 28 (e.g. tape, adhesive)

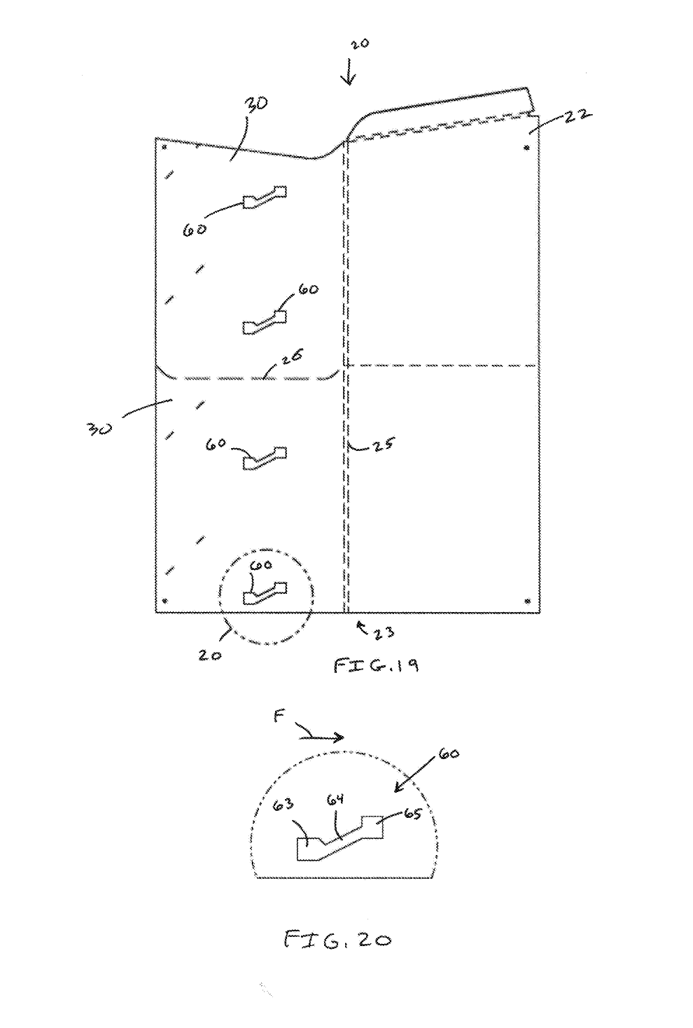

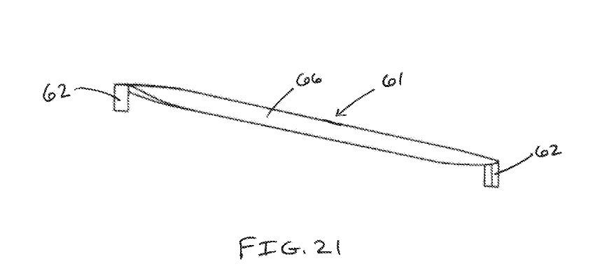

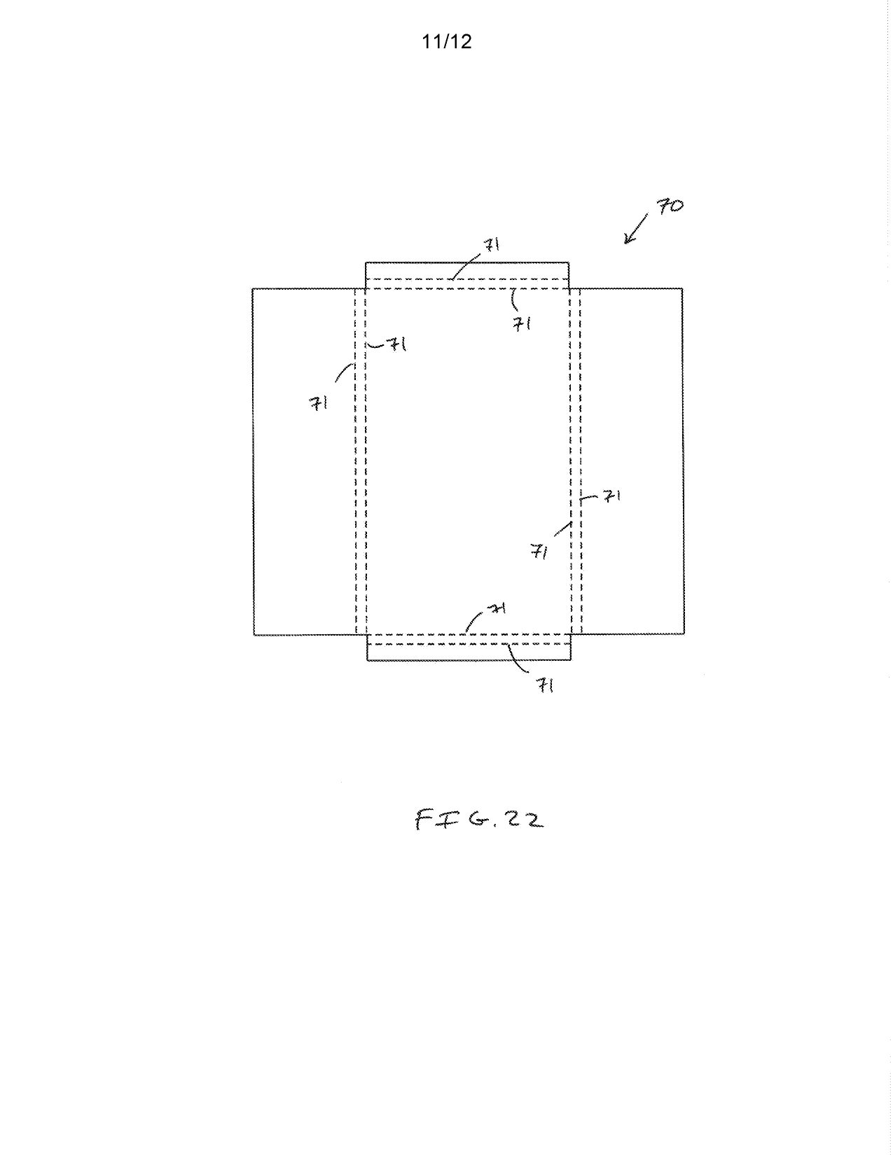

Referring to FIG. 19-20, a partial view of an example frame 20 includes a cutout 60 in the first sidewall 30. One of ordinary skill in the art will also recognize that a corresponding and aligned cutout is defined in the second sidewall 40. The cutouts 60 are configured to receive ends 62 of a support bar 61 (see FIG. 21) such that the support bar 61 extends between sidewalls 30, 40 to further support the shelf 50. The cutout 60 includes a first section 63, a second section 64, and a third section 65. The sections 63, 64, 65 are in communication with each other. To attach the support bar 61 to the sidewalls 30, 40 the display unit 10 is move to the assembled position (FIG. 1). The each end 62 of the support bar 61 is then inserted into the first sections 63 of the corresponding cutouts 60 in the sidewalls 30, 40. The support bar 61 is then moved toward the front of the display unit 10 (along direction F, see also FIG. 1) such that the ends 62 of the support bar 61 slide along the second section 64 of the cutout 60 and into the third section 65 of the cutout 60. The support bar 61 support and/or contacts/abuts the shelf 50 when the ends 62 of the support bar 61 are in the third section 65 of the cutout 60. The support bar 61 can be made of any suitable material (e.g. plastic, metal), and the shape of the support bar 61 can vary. In the example depicted in FIG. 21, the support bar 61 is a cylindrical tube with crimped or flattened ends 62 that form right angles to a center section 66 of the support bar.

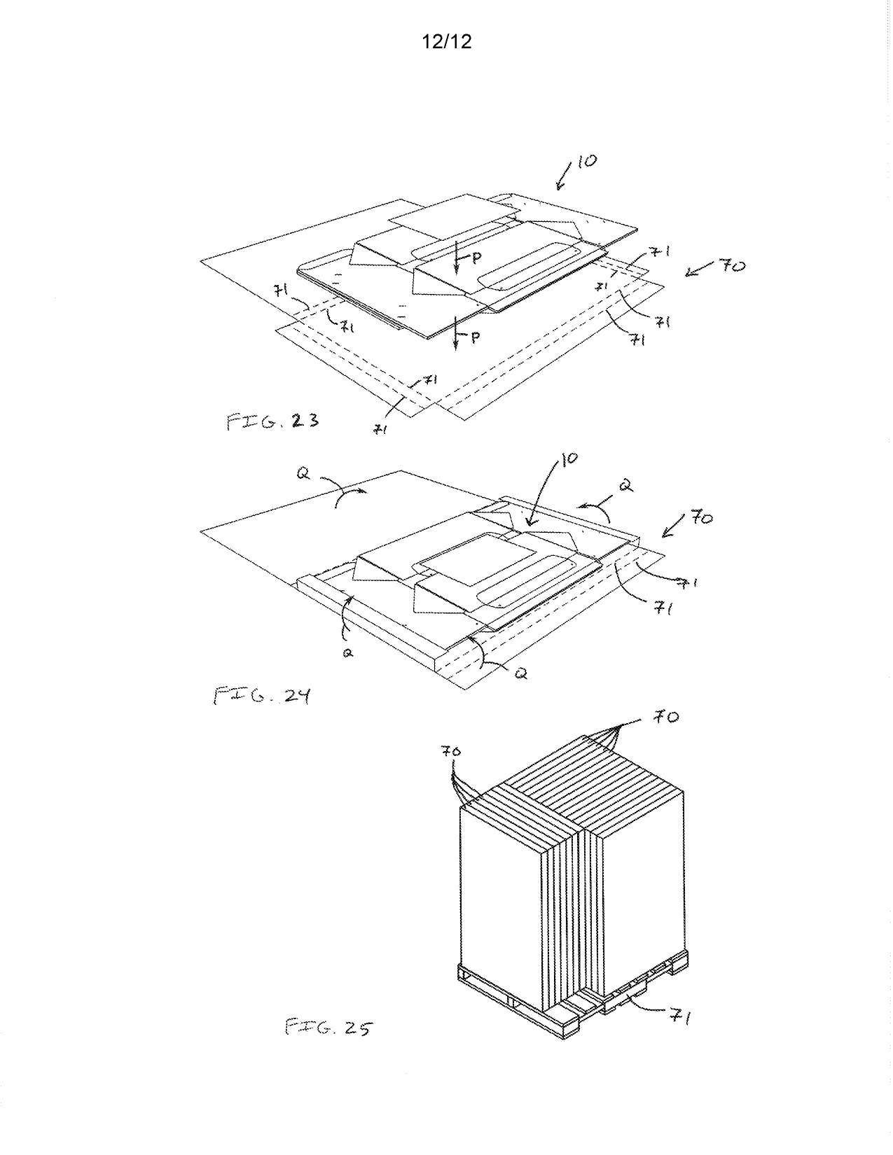

Referring to FIGS. 22-25, an optional shipping box 70 encloses the display unit 10 in the disassembled position (FIG. 2) to thereby protect and keep the display unit 10 clean. The shipping box 70 has a plurality of score lines 71 that facilitate folding of the shipping box 70 to thereby enclose and protect the display unit 10. FIG. 23 depicts the display unit 10 in the disassembled position (FIGS. 2) being placed (see motion arrow P) onto an “unfolded” shipping box 70. FIG. 24 depicts the shipping box 70 being folded (see fold arrows Q) to enclose the display unit. FIG. 25 depicts multiple shipping boxes 70 arranged on a pallet 72 for transportation and/shipping. The shipping box 70 can be made out of any suitable material such as corrugated paperboard, plastic, and/or the like. The size and/or shape of the shipping box 70 can vary (examples of the shipping boxes 70 are depicted in FIG. 22 and FIG. 23).

In the present description, certain terms have been used for brevity, clearness and understanding. No unnecessary imitations are to be implied therefrom beyond the requirement of the prior art because such terms are used for descriptive purposes only and are intended to be broadly construed. The different apparatuses described herein may be used alone or in combination with other apparatuses. Various equivalents, alternatives, and modifications are possible within the scope of the appended claims.

What is claimed is:

1. A display unit movable between a disassembled position and an assembled position, the display unit comprising:
a back wall having a first side end and a second side end opposite the first side end;
a first sidewall extending from the first side end, wherein the first sidewall is coplanar with the back wall when the display unit is in the disassembled position and transverse to the back wall when the display unit is in the assembled position;
a second sidewall extending from the second side end, wherein second sidewall is coplanar with the back wall when the display unit is in the disassembled position and transverse to the back wall when the display unit is in the assembled position; and
a shelf having a support surface, the shelf being operably coupled to the back wall, the first sidewall, and the second sidewall such that the support surface is parallel to the back wall when the display unit is in the disassembled position, and wherein the support surface is transverse to and extends from the back wall when the display unit is in the assembled portion.

2. The display unit according to claim 1, wherein the back wall has a first back wall portion and a second back panel portion opposite the first back panel portion; wherein the first back panel portion is parallel to the second back panel portion when the display unit is in the disassembled position; and wherein the first back panel portion and the second back wall portion are coplanar when the display unit is in the assembled position.

3. The display unit according to claim 2, wherein the first sidewall has a first sidewall portion and a second sidewall portion opposite the first sidewall portion; wherein the first sidewall portion is parallel to the second sidewall portion when the display unit is in the disassembled position; and wherein the first sidewall portion and the second sidewall portion are coplanar when the display unit is in the assembled position; and
wherein the second sidewall has third sidewall portion and a fourth sidewall portion opposite the third sidewall portion; wherein the third sidewall portion is parallel to the fourth sidewall portion when the display unit is in the disassembled position; and wherein the third sidewall portion and the fourth sidewall portion are coplanar when the display unit is in the assembled position.

4. The display unit according to claim 3, wherein the back wall has a score line disposed between the first back wall portion and the second back wall portion;
wherein the first sidewall has a score line that is aligned with the score line of the back wall and disposed between the first sidewall portion and the second sidewall portion; and
wherein the second sidewall has a score line that is aligned with the score line of the back wall and disposed between the third sidewall portion and the fourth sidewall portion.

5. The display unit according to claim 1, wherein the shelf has a first panel attached to the first sidewall, a second panel attached to the second sidewall, and a third panel attached to the back wall.

6. The display unit according to claim 5, wherein the shelf has a fourth panel configured to abut the first sidewall when the display unit is in the assembled position; and
wherein the shelf has a fifth panel configured to abut the second sidewall when the display unit is in the assembled position.

7. The display unit according to claim 6, further comprising a first fastener configured to couple fourth panel to the first sidewall; and a second fastener configured to couple the fifth panel to the second sidewall.

8. The display unit according to claim 7, wherein the first fastener removably couples the fourth panel to the first sidewall and the second fastener removably couples the fifth attachment portion to the second sidewall; and
wherein the first fastener and the second fastener are hook-and-loop strips.

9. The display unit according to claim 5, wherein the shelf is one of a plurality of shelves each having a support surface; and wherein the plurality of shelves are aligned relative to each other such that each of the support surfaces are transverse to and extend from the back wall when the display unit is in the assembled position.

10. The display unit according claim 9, wherein the each shelf is a single contiguous panel of material.

11. The display unit according claim 5, further comprising a support bar configured to extend between the first sidewall and the second sidewall and thereby support the shelf.

12. The display unit according to claim 11, wherein first sidewall defines a first cutout and the second sidewall defines a second cutout that corresponds and aligns with the first cutout when the display unit is in the assembled position; and wherein the support bar that engages with the first cutout and the second cutout to thereby support the shelf.

13. A display unit movable between a disassembled position and an assembled position, the display unit comprising:
a back wall having a first side end, a second side end opposite the first side end, a first back wall portion, and a second back panel portion opposite the first back panel portion; wherein the first back panel portion is parallel to the second back panel portion when the display unit is in the disassembled position; and wherein the first back panel portion and the second back wall portion are coplanar when the display unit is in the assembled position;
a first sidewall extending from the first side end, wherein the first sidewall is coplanar with the back wall when the display unit is in the disassembled position and transverse to the back wall when the display unit is in the assembled position;
a second sidewall extending from the second side end, wherein second sidewall is coplanar with the back wall when the display unit is in the disassembled position and transverse to the back wall when the display unit is in the assembled position, and wherein the second sidewall and the first sidewall are parallel to each other when the display unit is in the assembled position; and
a shelf having a support surface and a lip, the shelf being operably coupled to the back wall, the first sidewall, and the second sidewall such that the support surface and the lip are parallel to the back wall when the display unit is in the disassembled position, and wherein the support surface is transverse to and extends from the back wall and the lip is transverse to the support surface when the display unit is in the assembled position.

14. The display unit according to claim 13, wherein the back wall has a score line disposed between the first back wall portion and the second back wall portion;
wherein the first sidewall has a score line that is aligned with the score line of the back wall such that the first sidewall has a first sidewall portion and a second sidewall portion opposite the first sidewall portion, the first sidewall portion is parallel to the second sidewall portion when the display unit is in the disassembled position and the first sidewall portion and the second sidewall portion are coplanar when the display unit is in the assembled position; and
wherein the second sidewall has a score line that is aligned with the score line of the back wall such that the second sidewall has a second sidewall portion and a second sidewall portion opposite the first sidewall portion, the third sidewall portion is parallel to the fourth sidewall portion when the display unit is in the disassembled position; and wherein the third sidewall portion and the fourth sidewall portion are coplanar when the display unit is in the assembled position.

15. The display unit according to claim 14, wherein the shelf has a first panel attached to the first sidewall, a second panel attached to the second sidewall, a third panel attached to the back wall, a fourth panel configured to abut the first sidewall when the display unit is in the assembled position, and a fifth panel configured to abut the second sidewall when the display unit is in the assembled position.

16. The display unit according to claim 15, further comprising a first fastener configured to couple fourth panel to the first sidewall; and a second fastener configured to couple the fifth panel to the second sidewall.

17. The display unit according to claim 15, wherein the shelf is one of a plurality of shelf each having a support surface and a lip; and wherein the shelves are aligned relative to each other such that each of the support surfaces are transverse to and extend from the back wall and the lips are transverse to the support surfaces when the display unit is in the assembled position.

18. The display unit according claim 17, wherein the each shelf is a single contiguous panel of material.

19. The display unit according claim 18, wherein the back wall, the first sidewall, and the second sidewall are an integral single contiguous panel.

20. The display unit according claim 15, further comprising a support bar configured extend between the first sidewall and the second sidewall and thereby support the shelf.

21. A display unit movable between a disassembled position and an assembled position, the display unit comprising:
a back wall having a first side end and a second side end opposite the first side end;
a first sidewall extending from the first side end, wherein the first sidewall is coplanar with the back wall when the display unit is in the disassembled position and transverse to the back wall when the display unit is in the assembled position;
a second sidewall extending from the second side end, wherein second sidewall is coplanar with the back wall when the display unit is in the disassembled position and transverse to the back wall when the display unit is in the assembled position; and
a shelf having a support surface and a lip, the shelf being operably coupled to the back wall, the first sidewall, and the second sidewall such that the support surface and the lip are parallel to the back wall when the display unit is in the disassembled position, and wherein the support surface is transverse to and extends from the back wall and the lip is transverse to the support surface when the display unit is in the assembled portion.

22. The display unit according to claim 21, wherein the back wall has a first back wall portion and a second back panel portion opposite the first back panel portion; wherein the first back panel portion is parallel to the second back panel portion when the display unit is in the disassembled position; and wherein the first back panel portion and the second back wall portion are coplanar when the display unit is in the assembled position.

23. The display unit according to claim 22, wherein the shelf has a first panel attached to the first sidewall, a second panel attached to the second sidewall, a third panel attached to the back wall, a fourth panel configured to abut the first sidewall when the display unit is in the assembled position, and a fifth panel configured to abut the second sidewall when the display unit is in the assembled position; and further comprising a first fastener configured to couple fourth panel to the first sidewall; and a second fastener configured to couple the fifth panel to the second sidewall.

24. The display unit according to claim 23, wherein the shelf is one of a plurality of shelves each having a support surface and a lip; and wherein the plurality of shelves are aligned relative to each other such that each of the support surfaces are transverse to and extend from the back wall and the lips are transverse to the support surfaces when the display unit is in the assembled position.
